(19) United States
(12) Patent Application Publication
(10) Pub. No.: US 2026/0052358 A1
(43) Pub. Date: Feb. 19, 2026

(54) METHOD AND APPARATUS OF SUPPORTING MULTICAST AND BROADCAST SERVICES

(71) Applicant: LENOVO (BEIJING) LIMITED, Beijing (CN)

(72) Inventors: Mingzeng Dai, Shanghai (CN); Congchi Zhang, Shanghai (CN); Xiaoying Xu, Shanghai (CN); Lianhai Wu, Beijing (CN); Jing Han, Beijing (CN)

(21) Appl. No.: 19/101,953

(22) PCT Filed: Aug. 8, 2022
(86) PCT No.: PCT/CN2022/110815

§ 371 Date: Feb. 7, 2025

(51) Int. Cl. H04W 4/06; H04W 36/00

(52) U.S. Cl. CPC H04W 4/06; H04W 36/0007

(57) ABSTRACT

Embodiments of the present application relate to a method and apparatus of supporting multicast and broadcast services. An exemplary UE may include: a transceiver; and a processor coupled to the transceiver, wherein the processor is configured to: transmit, via the transceiver, HFN ambiguity indication information to a RAN node, indicating that there is ambiguity in HFN of received PDCP data PDU associated with a multicast MRB in the UE; and perform a reconfiguration procedure of PDCP state variable of the multicast MRB in response to receiving information indicating a reconfigured PDCP state variable value for the multicast MRB.

### TECHNICAL FIELD

Embodiments of the present application generally relate to wireless communication technology, especially to a method and apparatus of supporting multicast/broadcast services (MBS), e.g., multicast MBS radio bearer (MRB).

### BACKGROUND

In new radio (NR) Rel-17, the MBS plans to focus on a small area mixed mode multicast (also referred to as Objective A in the TR 23.757). The Objective A is about enabling general MBS services over 5G system (5GS) and the identified use cases that could benefit from this feature. These use cases include but are not limited to: public safety and mission critical, vehicle to everything (V2X) applications, transparent internet protocol version 4 (IPv4)/internet protocol version 6 (IPv6) multicast delivery, internet protocol television (IPTV), software delivery over wireless, group communications and internet of things (IOT) applications.

In NR MBS, the packet data convergence protocol (PDCP) entity is common for the point to multipoint (PTM) leg and point to point (PTP) leg. Since the PTM leg is used for multicast session(s) for multiple user equipment (UE), for a UE later joining the multicast session(s), PDCP related initial values for each state variables cannot always be “0” as legacy unicast, regardless of whether the first received MBS data packet comes from the PTM leg or PTP leg. The PDCP related initial values include the initial value for PDCP sequence number (SN) and PDCP hyper frame number (HFN), wherein the initial value of PDCP HFN can be indicated by the network to avoid HFN desynchronization.

However, in some scenarios, the PDCP entity for MRB may need to be re-established. For example, due to the mobility of UE, e.g., in radio resource control (RRC) non-connected state and RRC connected state, PDCP entity establishment maybe performed in response to a cell reselection to a neighbor cell in a RRC inactive state or a handover to a target gNB in the RRC connected state. In addition, a RRC based MRB type change may also cause a PDCP entity re-establishment. How to set the PDCP related initial values and PDCP status report in these scenarios also needs to be solved.

Given the above, the industry desires an improved technology for multicast and broadcast services, to enhance service continuity in scenarios that may need PDCP entity re-establishment, e.g., due to UE mobility or RRC state transition etc.

### SUMMARY OF THE APPLICATION

Embodiments of the present application at least provide a technical solution of supporting multicast and broadcast services, especially providing a technical solution of supporting MBS by reconfiguring PDCP related initial values for multicast MRB in some scenarios that may cause PDCP entity establishment, e.g., occurrence of cell reselection or handover. In addition, embodiments of the present application also provide a technical solution of PDCP status reporting in response to reconfiguring the PDCP related initial values.

Some embodiments of the present application provide a UE, which may include: a transceiver; and a processor coupled to the transceiver, wherein the processor is configured to: transmit, via the transceiver, HFN ambiguity indication information to a RAN node, indicating that there is ambiguity in HFN of received PDCP data protocol data unit (PDU) associated with a multicast MRB in the UE; and perform a reconfiguration procedure of PDCP state variable of the multicast MRB in response to receiving information indicating a reconfigured PDCP state variable value for the multicast MRB.

In some embodiments of the present application, the reconfigured PDCP state variable value includes reconfigured HFN and reference SN of the multicast MRB.

In some embodiments of the present application, the processor is configured to: inherit PDCP state variable values of the received PDCP data PDU counted in a RRC connected state for continuing reception of the multicast MRB in the RRC inactive state in response to RRC state transition from the RRC connected state to the RRC inactive state.

In some embodiments of the present application, the RAN node is a receiving RAN node in the case of occurrence of a cell reselection due to mobility of the UE in a RRC inactive state.

According to some embodiments of the present application, the processor is configured to: inherit PDCP state variable values of the received PDCP data PDU counted in an a source cell before the cell reselection for continuing reception of the multicast MRB in a selected cell after the cell reselection in response to the cell reselection.

According to some embodiments of the present application, the processor is configured to: identify the multicast MRB with an associated MRB identity (ID) in a selected cell; and associate the multicast MRB with a PDCP entity for the multicast MRB in response to the cell reselection to inherit PDCP state variable values of the received PDCP data PDU counted in a source cell before the cell reselection. The associated MRB ID in the selected cell is received via a RRC dedicated signaling, or via multicast control channel (MCCH) from a last serving RAN node before the cell reselection, or via MCCH from the receiving RAN node after the cell reselection.

In some embodiments of the present application, the RAN node is a serving RAN node of the UE, and the HFN ambiguity indication information is transmitted in response to a PDCP entity re-establishment for the multicast MRB.

In some embodiments of the present application, performing the reconfiguration procedure of PDCP state variable of the multicast MRB includes the following: setting a state variable indicating a count value of a first PDCP service data unit (SDU) not delivered to upper layers but still waited for to the reconfigured PDCP state variable value; and delivering all stored PDCP SDUs to the upper layers in an ascending order of associated count values. In some other embodiments of the present application, performing the reconfiguration procedure of PDCP state variable of the multicast MRB includes the following: in the case that an existing value of a state variable indicating a count value of a first PDCP SDU not delivered to upper layers is behind or lower than the reconfigured PDCP state variable value, setting a state variable indicating a count value of a first PDCP SDU not delivered to upper layers but still waited for to the reconfigured PDCP state variable value; and delivering all stored PDCP SDUs to the upper layers in an ascending order of associated count values; and in the case that the exiting value of a state variable indicating a count value of a first PDCP SDU not delivered to upper layers is ahead or larger than the reconfigured PDCP state variable value, maintaining existing values of PDCP variables for the multicast MRB. In some scenarios, performing the reconfiguration procedure of PDCP state variable of the multicast MRB may further include: stopping a timer for detecting PDCP data lost being running and resetting the timer, in the case of setting the state variable indicating a count value of a first PDCP SDU not delivered to upper layers but still waited for to the reconfigured PDCP state variable value.

In some embodiments of the present application, the processor is configured to set a PDCP status report for the multicast MRB based on PDCP state variable values before performing the reconfiguration procedure. For example, setting the PDCP status report for the multicast MRB based on the PDCP state variable values before performing the reconfiguration procedure includes: storing a state variable indicating a count value of a first PDCP SDU not delivered to upper layers but still waited for and bitmaps for the PDCP status report according to latest receiving status of the multicast MRB before setting the state variable with the reconfigured PDCP state variable value; or generating the PDCP status report before setting the state variable with the reconfigured PDCP state variable value.

In some embodiments of the present application, the HFN ambiguity indication information indicates that cell reselection occurred during reception of the multicast MRB to implicitly indicate that there is ambiguity in the HFN of the received PDCP data PDU in the UE.

In some embodiments of the present application, the HFN ambiguity indication information is transmitted via a RRC message or a PDCP control PDU.

In some embodiments of the present application, the processor is configured to receive information indicating that a PDCP state variable for the multicast MRB is reconfigured.

Some other embodiments of the present application provide a RAN node, e.g., a receiving gNB, which includes: a transceiver; and a processor coupled to the transceiver, wherein the processor is configured to: receive, via the transceiver, HFN ambiguity indication information from a UE, indicating that there is ambiguity in HFN of received PDCP data PDU of a multicast MRB in the UE; and transmit, via the transceiver, information indicating a reconfigured PDCP state variable value for the multicast MRB according to the HFN ambiguity indication information.

In some embodiments of the present application, the RAN node is a receiving RAN node in the case of occurrence of a cell reselection due to mobility of the UE in a RRC inactive state.

According to some embodiments of the present application, the processor is configured to: receive a request from a last serving RAN node of the UE, requesting an associated MRB ID of the multicast MRB in each of one or more cells belonging to the receiving RAN node; and transmit the associated MRB ID in each of at least part of the one or more cells in response to the request.

In some embodiments of the present application, the RAN node is a serving RAN node of the UE, and the HFN ambiguity indication information is transmitted in response to a PDCP entity re-establishment for the multicast MRB.

In some embodiments of the present application, the HFN ambiguity indication information indicates that cell reselection occurred during reception of the multicast MRB to implicitly indicate there is ambiguity in HFN of received PDCP data PDU in the UE.

Some yet other embodiments of the present application provide a RAN node, e.g., a last serving gNB, which includes: a transceiver; and a processor coupled to the transceiver, wherein the processor is configured to: transmit, via the transceiver, configuration information for reception of a multicast MRB to a UE in a RRC connected state; and transmit, via the transceiver, information indicating at least one associated MRB ID of the multicast MRB to the UE in response to that the UE transits to a RRC inactive state from the RRC connected state, wherein each associated MRB ID of the multicast MRB is associated with a corresponding neighbor cell belonging to an associated one of at least one neighbor RAN node of the RAN node.

In some embodiments of the present application, before releasing the UE to the RRC inactive state, the processor is configured to: transmit at least one request to the at least one neighbor RAN node of the RAN node, each request to a corresponding neighbor RAN node requesting an associated MRB ID of the multicast MRB in each of one or more cells belonging to the corresponding neighbor RAN node; and receive the at least one associated MRB ID from the at least one neighbor RAN node.

Some yet other embodiments of the present application provide a RAN node, e.g., a last serving gNB, which includes: a transceiver; and a processor coupled to the transceiver, wherein the processor is configured to: decide to handover a UE during reception of a multicast MRB to a target RAN node; and transmit, via the transceiver, information related to a latest count value of transmitted PDCP data PDU of the multicast MRB to the target RAN node.

In some embodiments of the present application, the information related to a latest count value of transmitted PDCP data PDU indicates one of the following:
highest PDCP count value of PDCP PDU of the multicast MRB transmitted to the UE in the RAN node;
highest HFN value of PDCP PDU of the multicast MRB transmitted to the UE in the RAN node;
highest PDCP count value of PDCP PDU of the multicast MRB transmitted to UE successfully in order in the RAN node; and
highest HFN value of PDCP PDU transmitted to UE successfully in order in the RAN node.

Some yet other embodiments of the present application provide a RAN node, e.g., a target gNB, which includes: a transceiver; and a processor coupled to the transceiver, wherein the processor is configured to: receive, via the transceiver, from a source RAN node of a UE, information related to a latest count value of transmitted PDCP data PDU of a multicast MRB; determine whether to reconfigure PDCP state variables for the multicast MRB based on the information related to a latest count value of transmitted PDCP data PDU and transmission status of the multicast MRB in the RAN node; and transmit, via the transceiver, to the UE, information indicating a reconfigured PDCP state variable value in response to determining to reconfigure the PDCP state variables.

In some embodiments of the present application, the information related to a latest count value of transmitted PDCP data PDU indicates one of the following:
highest PDCP count value of PDCP PDU of the multicast MRB transmitted to the UE in the source RAN node;
highest HFN value of PDCP PDU of the multicast MRB transmitted to the UE in the source RAN node;
highest PDCP count value of PDCP PDU of the multicast MRB transmitted to UE successfully in order in the source RAN node; and
highest HFN value of PDCP PDU transmitted to UE successfully in order in the source RAN node.

According to some embodiments of the present application, determining whether to reconfigure PDCP state variables for the multicast MRB includes: deciding to reconfigure the PDCP state variables in the case that a highest PDCP count value of PDCP PDU of the multicast MRB to be transmitted to the UE in the RAN node is larger than the highest PDCP count value indicated in the information related to a latest count value of transmitted PDCP data PDU, or in the case that a highest HFN value of PDCP PDU of the multicast MRB to be transmitted to the UE in the RAN node is larger than the highest HFN value indicated in the information related to a latest count value of transmitted PDCP data PDU.

According to some other embodiments of the present application, determining whether to reconfigure PDCP state variables for the multicast MRB includes: deciding to maintain the PDCP state variables in the case that difference between a highest PDCP count value of PDCP PDU of the multicast MRB to be transmitted to the UE in the RAN node and the highest PDCP count value indicated in the information related to a latest count value of transmitted PDCP data PDU is smaller than a threshold, or in the case that difference between a highest HFN value of PDCP PDU of the multicast MRB to be transmitted to the UE side in the RAN node and the highest HFN value indicated in the information related to a latest count value of transmitted PDCP data PDU is smaller than a threshold.

In some embodiments of the present application, in response to determining to reconfigure the PDCP state variables, the processor is configured to: transmit information indicating that a PDCP state variable for the multicast MRB is reconfigured to the UE.

In view of the above, embodiments of the present application provide a technical solution of supporting MBS, which can reconfigure PDCP related initial values for multicast MRB in some scenarios that need PDCP entity establishment and avoid the PDCP HFN desynchronization between the remote side and the network side. In addition, embodiments of the present application can enhance service continuity by reducing data missing and avoiding forwarding unnecessary PDCP data PDU to upper layers.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application.

FIG. 2 illustrates an exemplary procedure of a method of supporting MBS according to some embodiments of the present application.

FIG. 3 illustrates an exemplary procedure of a method of supporting MBS according to some other embodiments of the present application.

FIG. 4 illustrates an exemplary procedure of a method of supporting MBS according to some yet other embodiments of the present application.

FIG. 5 illustrates a simplified block diagram of an apparatus of supporting MBS according to some embodiments of the present application.

FIG. 6 illustrates a simplified block diagram of an apparatus of supporting MBS according to some other embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. Persons skilled in the art know very well that, with the development of network architecture and new service scenarios, the embodiments in the present application are also applicable to similar technical problems.

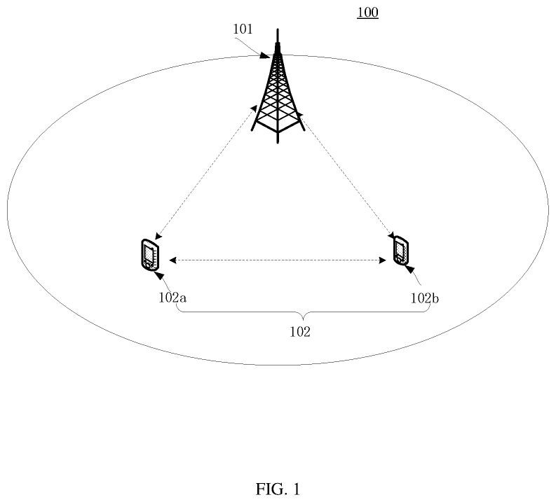

FIG. 1 illustrates a schematic diagram of an exemplary wireless communication system 100 according to some embodiments of the present application.

As shown in FIG. 1, the wireless communication system 100 includes at least one BS 101 and at least one UE 102. In particular, the wireless communication system 100 includes one BS 101 and two UE 102 (e.g., a UE 102a and UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a core network (CN) node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a radio access network (RAN) node. Each BS may serve a number of UE(s) within a serving area, for example, a cell or a cell sector via a wireless communication link. Neighbor BSs may communicate with each other as necessary, e.g., during a handover procedure for a UE.

The UE 102, e.g., the UE 102a and UE 102b may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

A UE can be configured to receive MBS, e.g., multicast MRB. Regarding reception operation of the UE, the receiving PDCP entity shall maintain the following PDCP state variables according to TS 38.323:

```
a) RX_NEXT
This state variable indicates the COUNT value of the next PDCP SDU expected
to be received. The initial value is 0, except for sidelink broadcast and groupcast,
and for SRBs configured with state variables continuation. For NR sidelink
communication for broadcast and groupcast, the initial value of the SN part of
RX_NEXT is (x +1) modulo (2^{[sl-PDCP-SN-Size]}), where x is the SN of the first
received PDCP Data PDU. For target SRB configured with state variables
continuation, the initial value is the value stored in PDCP entity for the
corresponding source SRB. For source SRB configured with state variables
continuation, the initial value is the value stored in PDCP entity for the
corresponding target SRB.
  NOTE 1: For NR sidelink communication for broadcast and groupcast or
    sidelink SRB4 for broadcast and groupcast based sidelink discovery,
    it is up to UE implementation to select the HFN part for RX_NEXT
    such that initial value of RX_DELIV should be a positive value.
  NOTE 2: For broadcast MRBs, the initial value of the HFN part of RX_NEXT
    is set by UE implementation.
b) RX_DELIV
This state variable indicates the COUNT value of the first PDCP SDU not
delivered to the upper layers, but still waited for. The initial value is 0, except for
sidelink broadcast and groupcast, and for SRBs configured with state variables
continuation. For NR sidelink communication for broadcast and groupcast, the
initial value of the SN part of RX_DELIV is (x − 0.5 × 2^{[sl-PDCP-SN-Size-1]}) modulo
(2^{[sl-PDCP-SN-Size]}), where x is the SN of the first received PDCP Data PDU. For
multicast MRBs, the initial value of RX_DELIV is set by multicastHFN-AndRefSN
in TS 38.331 [3]. For target SRB configured with state variables continuation, the
initial value is the value stored in PDCP entity for the corresponding source SRB.
For source SRB configured with state variables continuation, the initial value is
the value stored in PDCP entity for the corresponding target SRB.
c) RX_REORD
This state variable indicates the COUNT value following the COUNT value
associated with the PDCP Data PDU which triggered t-Reordering. For target
SRB configured with state variables continuation, the initial value is the value
stored in PDCP entity for the corresponding source SRB. For source SRB
configured with state variables continuation, the initial value is the value stored
in PDCP entity for the corresponding target SRB.
```

In order to avoid HFN desynchronization, the network will provide UE the initial value of HFN and reference PDCP SN associated with the HFN, e.g., by the multicastHFN-AndRefSN information element (IE) specified in TS 38.331, which is used for multicast MRB PDCP window initialization (or, PDCP state variable initialization for multicast MRB). For example, for multicast MRBs, the initial value of RX_DELIV is set by multicastHFN-AndRefSN. The multicastHFN-AndRefSN IE indicates a PDCP related initial value, e.g., multicastHFN-AndRefSN, which is composed of a HFN (HFN part, e.g. the number of most significant bits (MSB) equal to HFN length) and the PDCP SN (SN part, e.g., the number of least significant bits (LSB) equal to PDCP SN length). The size of the HEN part in bits is equal to 32 minus the length of the PDCP SN configured in pdcp-SN-SizeDL. According to TS 38.323, the UE will set the initial value of RX_DELIV by the PDCP related initial value indicated in multicastHFN-AndRefSN IE.

In addition, according to TS 38.323, at reception of a PDCP data PDU from lower layers (layers lower than PDCP layer) in the UE, the receiving PDCP entity will determine the COUNT value of the received PDCP data PDU, i.e. RCVD_COUNT, as follows:

| | |
|---|---|
| - | if RCVD_SN < SN(RX_DELIV) − Window_Size: |

| | |
|---|---|
| - | RCVD_HFN = HFN(RX_DELIV) + 1. |

| | |
|---|---|
| - | else if RCVD_SN >= SN(RX_DELIV) + Window_Size: |

| | |
|---|---|
| - | RCVD_HFN = HFN(RX_DELIV) − 1. |

| | |
|---|---|
| - | else: |

| | |
|---|---|
| - | RCVD_HFN = HFN(RX_DELIV); |

| | |
|---|---|
| - | RCVD_COUNT = [RCVD_HFN, RCVD_SN]. |

Wherein, the initial value of RX_DELIV is set by multicastHFN-AndRefSN; Window_Size is size of the reordering window, and the value equals to 2[pdcp-SN-SizeDL]−1 for SRB/DRB/MRB; RCVD_SN is the PDCP SN of the received PDCP data PDU, included in the PDU header; RCVD_HFN is the HFN of the received PDCP data PDU, calculated by the receiving PDCP entity; and RCVD_COUNT is the COUNT of the received PDCP Data PDU, being [RCVD_HFN, RCVD_SN]. The UE (the receiving PDCP entity) will determine the other values of PDCP state variables, such as RX_NEXT and RX_REORD according to RCVD_COUNT and RX_DELIV.

However, in some scenarios, a PDCP entity for multicast MRB may need to be re-established, which will cause some technical problems related to PDCP state variable initialization and PDCP status reporting for the multicast MRB.

For example, in a RRC inactive state, e.g., RRC_INACTIVE, the PTM configuration of a neighbor cell of a UE may be pre-configured. When the UE in RRC_INACTIVE enters the neighbor cell (new cell or reselected cell) by cell reselection, real time PDCP related initial values, e.g., multicastHFN-AndRefSN is not available for the UE. In addition, if the PTM configuration is provided by MCCH, the UE in RRC_INACTIVE will release the PDCP entity when leaving the source cell and setup a new PDCP entity when entering the new cell. Thus, service continuity of the MRB cannot be guaranteed. Meanwhile, the MRB IDs in different cells may be different for the same MBS traffic, and the UE cannot identify the same MBS traffic with the MRB ID in the source cell in the case that the MRB IDs in the source cell and new cell, e.g., the reselected cell are different. Thus, how to set initial values of the PDCP state variables for multicast MRB after entering the new cell by cell reselection needs to be solved.

In another example, during a handover or RRC based MRB bearer type change, the PDCP entity re-establishment may be performed. During the PDCP entity re-establishment, the UE will also set PDCP state variables of UnacknowledgedMod (UM) MRBs to a corresponding initial value according to TS 38.323, wherein for service radio bearers (SRBs), UM data radio bearers (DRBs) and UM MRBs, RX_NEXT and RX_DELIV will be set to the initial values. However, the initial values of UM MRBs are not available according to the configuration condition as specified in TS 38.331. Thus, how to handle the initial values of RX_NEXT and RX_DELIV for multicast MRB during the handover or RRC based MRB bearer type change also needs to be addressed.

In yet another example, for AcknowledgedMod (AM) MRBs configured by upper layers (layers upper than PDCP layer) to send a PDCP status report in uplink (e.g., statusReportRequired in TS 38.331), the receiving PDCP entity will trigger a PDCP status report when upper layers request a PDCP entity re-establishment or when upper layers request a PDCP data recovery. The PDCP status report includes a field “First Missing Count” (FMC) and bitmap, wherein the FMC indicates the COUNT value of the first missing PDCP SDU within the reordering window, i.e. RX_DELIV. However, during the PDCP entity re-establishment, RX_DELIV may be set to the initial value as illustrated above. Thus, how to generate the PDCP status report for the multicast MRB in such scenarios also needs to be solved.

At least for solving the above technical problems, embodiments of the present application propose an improved technical solution of supporting MBS, especially an improved technical solution of managing PDCP state variables in the receiving side by reconfiguring the PDCP state variables in scenarios that are supposed to need PDCP entity establishment and an improved technical solution of PDCP status reporting in response to reconfiguring the PDCP state variables. Herein, it is supposed that the UE supports multicast reception in both of the RRC connected state and RRC non-connected state, e.g., the RRC inactive state.

For example, some embodiments of the present application provide a method of supporting MBS, e.g., performed in the remote side. The exemplary method may include: transmitting HFN ambiguity indication information to a RAN node (e.g., in response to a cell reselection or handover) indicating that there is ambiguity in the HFN of the received PDCP data PDU associated with a multicast MRB in the UE, e.g., via a RRC message or a PDCP control PDU; and performing a reconfiguration procedure of PDCP state variable of the multicast MRB in response to receiving information indicating a reconfigured PDCP state variable value for the multicast MRB.

Some other embodiments of the present application provide another method of supporting MBS, e.g., performed in a receiving gNB, which may include: receiving HFN ambiguity indication information from a UE, indicating that there is ambiguity in HFN of received PDCP data PDU of a multicast MRB in the UE; and transmitting information indicating a reconfigured PDCP state variable value for the multicast MRB according to the HFN ambiguity indication information.

Some yet other embodiments of the present application provide yet another method of supporting MBS, e.g., performed in a last serving gNB, which may include: transmitting configuration information for reception of a multicast MRB to a UE in a RRC connected state; and transmitting information indicating at least one associated MRB ID of the multicast MRB to the UE in response to that the UE transits to a RRC inactive state from the RRC connected state, wherein each associated MRB ID of the multicast MRB is associated with a corresponding neighbor cell belonging to an associated one of at least one neighbor RAN node of the RAN node.

Some yet other embodiments of the present application provide yet another method of supporting MBS, e.g., performed in a last serving gNB, which may include: deciding to handover a UE during reception of a multicast MRB to a target RAN node; and transmitting information related to a latest count value of transmitted PDCP data PDU of the multicast MRB to the target RAN node.

Some yet other embodiments of the present application provide yet another method of supporting MBS, e.g., performed in a target gNB, which may include: receiving from a source RAN node of a UE, information related to a latest count value of transmitted PDCP data PDU of a multicast MRB; determining whether to reconfigure PDCP state variables for the multicast MRB based on the information related to a latest count value of transmitted PDCP data PDU and transmission status of the multicast MRB in the RAN node; and transmitting to the UE, information indicating a reconfigured PDCP state variable value in response to determining to reconfigure the PDCP state variables.

More detailed embodiments will be illustrated in view of some exemplary scenarios in the following.

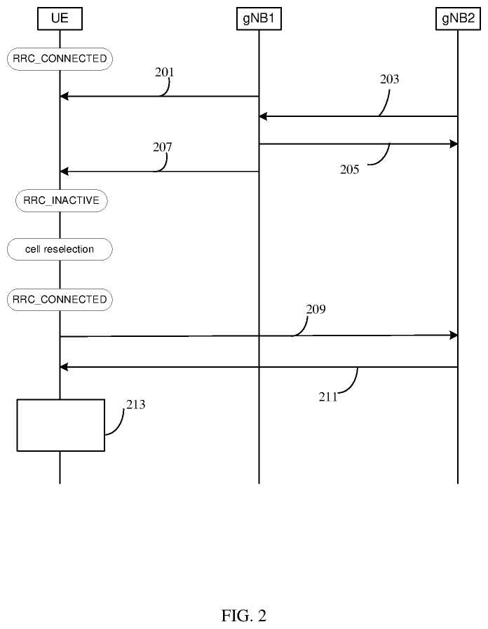

FIG. 2 illustrates an exemplary procedure of a method of supporting MBS according to some embodiments of the present application, wherein cell reselection occurs and MRB configuration information for multicast reception in RRC non-connected state, e.g., RRC inactive state, is transmitted to the UE side via RRC dedicated signaling. Although the method is illustrated in a system level among a UE, a last serving RAN node of the UE, e.g., gNB 1 (also referred to as: a last serving gNB, anchor gNB, old serving gNB, old gNB, last serving RAN side, last serving gNB side or last serving NG-RAN or the like) and a receiving RAN node of the UE, e.g., gNB 2 (also referred to as: a receiving gNB, new serving gNB, new gNB, receiving RAN side, new serving gNB side or new NG-RAN or the like); persons skilled in the art should understand that the method implemented in the UE, last serving RAN node and receiving RAN node can be separately implemented and/or incorporated by other apparatus with the like functions.

Referring to FIG. 2, for a UE in a RRC connected state (RRC_CONNECTED), e.g., in a first cell belonging to gNB1, the network side, e.g., gNB1 may transmit MRB configuration information for multicast reception in RRC connected state (hereafter, first MRB configuration information) to the UE in step 201 so that the UE can receive multicast MRB (or perform multicast reception of MRB). The first MRB configuration information can be transmitted via a RRC dedicated signaling, e.g., RRCReconfiguration message. gNB1 will provide a PDCP related initial value to the UE for the multicast reception of the MRB, e.g., by including the multicastHFN-AndRefSN IE as specified in TS 38.331 in the first MRB configuration information.

Consistently, the UE will receive the multicast MRB according to the first MRB configuration information. Wherein, the UE will use the indicated PDCP related initial value to set the initial values of PDCP state variables, e.g. setting RX_DELIV to the PDCP related initial value indicated in multicastHFN-AndRefSN IE. Then, the UE will determine the count value of the received PDCP data PDU, e.g., RCVD_COUNT as specified in TS 38.323.

In some scenarios, the UE will be released (or sent) to a RRC non-connected state, e.g., a RRC inactive state (RRC_INACTIVE), and gNB1 may configure the UE to continue the multicast reception in the RRC inactive state. Then, before sending the UE to the RRC inactive state, gNB1 may decide a list of cells where the UE may receive the multicast MRB in the RRC non-connected state. The cells on the list may belong to gNB1 and/or neighbor RAN node(s) including gNB2. Although only gNB2 is illustrated herein, persons skilled in the art should well know that there may be more neighbor RAN nodes. In step 203, gNB1 may transmit a request, e.g., by Xn-application protocol (AP) signaling to each neighbor RAN node where one or more cells in the list of cells belong. Each request to a corresponding neighbor RAN node will request an associated MRB ID of the multicast MRB in each cell belonging to the corresponding neighbor RAN node.

In response to the request, the corresponding neighbor RAN node, e.g., gNB2 will transmit the associated MRB ID in each corresponding cell (partial or all of the one or more cells) to gNB1 in step 205, e.g., by Xn-AP signaling. The associated MRB IDs in different cells may be the same or different. Accordingly, gNB1 will receive at least one MRB ID in a set of cells from the neighbor RAN nodes including gNB2.

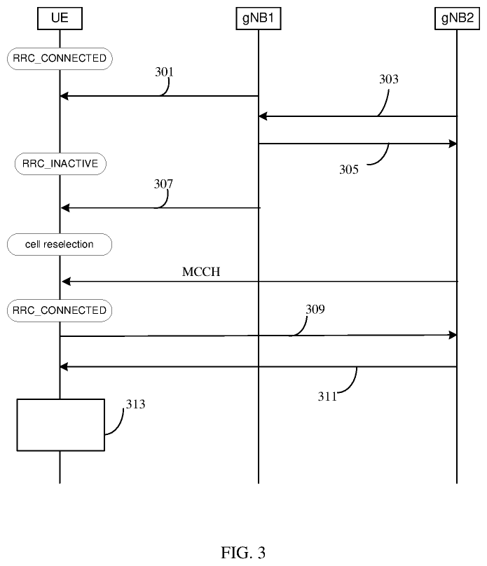

gNB1 will also provide MRB configuration information for multicast reception in the RRC non-connected state (hereafter second MRB configuration information) to the UE, which may be transmitted via RRC dedicated signaling or MCCH. In embodiments illustrated in FIG. 2, the second MRB configuration information will be provided by RRC dedicated signaling, while in embodiments illustrated in FIG. 3, the second MRB configuration information will be provided by MCCH (which will be further illustrated in the following).

For example, in some embodiments of the present application, gNB1 will also request the second MRB configuration information in each corresponding cell from the associated neighbor gNB, e.g., gNB2 to which the corresponding cell belongs, e.g., also via the request in step 203. gNB2 will provide the second MRB configuration information, e.g., with the associated MRB ID in partial or all of the required cell(s) to gNB1, e.g., in step 205. gNB1 may also provide MBS quality of service (QOS) flow to MRB mapping in gNB1 to the corresponding neighbor gNB, e.g., gNB2. The corresponding neighbor gNB may apply the received MBS QoS flow to MRB mapping to the same MBS QoS flows.

In some other embodiments of the present application, gNB1 may configure the UE to continue receiving the multicast MRB in the RRC inactive state with the first MRB configuration information by transmitting an indication indicating that the UE will continue using the first MRB configuration information for multicast reception in the RRC non-connected state, e.g., in RRCRelease message. Since the dedicated configuration part is not scalable for UE in a RRC non-connected state, for multicast reception in RRC non-connected state, the UE substantially can only continue using the common configuration part of the first MRB configuration information.

Whatever, in step 207, gNB1 will transmit the associated MRB IDs of the set of cells to the UE by at least one RRC dedicated signaling, e.g., with (e.g., included in) the second configuration information received from the neighbor RAN nodes or with the indication indicating that the UE will continue using the first MRB configuration information for multicast reception in the RRC non-connected state. For example, it is supposed that the second configuration information with the associated MRB ID of all the cells in the list are obtained by gNB1, and gNB1 will transmit the second configuration information with the associated MRB ID of all the cells in the list to the UE. The RRC dedicated signaling carrying the associated MRB IDs may be a RRC dedicated signaling to be received by the UE in the RRC connected state, e.g., RRCReconfiguration message, or a RRC dedicated signaling to be received by the UE during a state transition from the RRC connected state to the RRC non-connected state, e.g., RRCRelease message.

Consistently, in the remote side, the UE will receive at least one signaling indicating the second MRB configuration information with the associated MRB IDs. After entering the RRC non-connected state, e.g., RRC inactive state, the UE will receive the multicast MRB in the RRC inactive state based on the received second MRB configuration information. The UE will inherit the PDCP state variable values of the received PDCP data PDU counted in the RRC connected state for continuing reception of the multicast MRB in the RRC inactive state. For example, the UE will continue using the latest PDCP variables of multicast reception in the RRC connected state for multicast reception in the RRC inactive state.

Due to the mobility of the UE, the UE may move out the coverage of gNB1 and move into the coverage of another RAN node, e.g., gNB2. It is supposed that the UE reselects a second cell (reselected cell) belonging to gNB2, that is, a cell reselection occurs, and the UE has the second MRB configuration information in the second cell. The UE will apply the corresponding second MRB configuration information of the reselected cell for multicast reception. The UE will identify the MRB with the associated MRB ID in the reselected cell and associate the MRB with the PDCP entity. There is no PDCP entity releasing and establishment. The UE will inherit the PDCP state variable values of the received PDCP data PDU in the source cell before the cell reselection (e.g., the first cell) for continuing reception of the multicast MRB in the reselected cell (e.g., the second cell).

For example, the UE will identify the multicast MRB with MRB ID #2 in the second cell is the same multicast MRB with MRB ID #1 in the first cell. The UE will associate the multicast MRB with MRB ID #2 to the PDCP entity of the multicast MRB with MRB ID #1 in the first cell, and will continue using the latest PDCP variables of the multicast reception in the source cell before cell reselection (e.g., the first cell) for multicast reception in the reselected cell after the cell reselection (e.g., the second cell).

In some scenarios, the UE may enter the RRC connected state from the RRC inactive state in the second cell by performing a RRC state transition. In step 209, the UE will transmit HFN ambiguity indication information to gNB2, indicating that there is ambiguity in HFN of the received PDCP data PDU associated with the multicast MRB, e.g., RCVD_HFN in the UE (or HFN of the received PDCP data PDU associated with the multicast MRB may be wrong in the UE). Persons skilled in the art should well know that the HFN ambiguity indication information is actually used to indicate that the receiving side is unsure the accuracy of the count value of the received PDCP data PDU due to the cell reselection or the like, e.g., handover etc., which may be expressed in other manners, and cannot be used to unduly to limit the scope of embodiments of the present application.

The HFN ambiguity indication information may be transmitted via a RRC message, e.g., RRCSetupComplete message or MBSInterestIndication message or other RRC message, or via a PDCP control PDU. Exemplary HFN ambiguity indication information is one bit indication using enumerated type. Another example of the HFN ambiguity indication information may implicitly indicate that there is ambiguity in the HFN of the received PDCP data PDU in the UE, e.g., by indicating that cell reselection occurred during reception of the multicast MRB.

After receiving the HFN ambiguity indication information, gNB2 may decide to reconfigure PDCP state variables for the multicast MRB, e.g., based on the implementation of gNB2. In step 211, gNB2 will transmit information indicating a reconfigured PDCP state variable value for the multicast MRB to the UE according to the HFN ambiguity indication information. An exemplary reconfigured PDCP state variable value is multicastHFN-AndRefSN in multicastHFN-AndRefSN IE included in a RRC message. Such an exemplary RRC message is RRCReconfiguration message. An exemplary reconfigured PDCP state variable value includes a reconfigured HFN and reference SN of the multicast MRB, which is similar to the PDCP related initial value as illustrated above. For example, the HFN part of the reconfigured PDCP state variable value is the number of MSB equal to HFN length and the SN part is the number of LSB equal to PDCP SN length. The size of the HFN part in bits is equal to 32 minus the length of the PDCP SN configured in pdcp-SN-SizeDL. In some embodiments of the present application, gNB2 may also transmit additional indication information indicating that a PDCP state variable for the multicast MRB is reconfigured to the UE, which can also be included in the multicastHFN-AndRefSN IE, e.g., by adding new indication information compared with legacy multicastHFN-AndRefSN IE.

In the case of receiving the information indicating a reconfigured PDCP state variable value for the multicast MRB, the UE will perform a reconfiguration procedure of PDCP state variable of the multicast MRB in step 213.

An exemplary reconfiguration procedure of PDCP state variable of the multicast MRB includes setting a state variable indicating a count value of a first PDCP SDU not delivered to upper layers but still waited for, e.g., RX_DELV to the reconfigured PDCP state variable value, which is similar to setting RX_DELV to the PDCP related initial value as specified in TS38.233 as illustrated above. The UE may also adjust other PDCP state variables, e.g., setting a state variable indicating a count value of a next PDCP SDU expected to be received, e.g., RX_NEXT to zero. If a timer for detecting PDCP data lost, e.g., t-Reordering is running, the UE will stop and reset the timer. In addition, the UE will deliver all stored PDCP SDUs to the upper layers, e.g., RRC layer etc. upper than the PDCP layer in an ascending order of associated count values, e.g., after performing header decompression.

In some other embodiments of the present application, to avoid forwarding unnecessary PDCP PDU to upper layers, the UE will first determine whether an existing value of a state variable indicating a count value of a first PDCP SDU not delivered to upper layers, e.g., RX_DELV is behind or lower than the reconfigured PDCP state variable value. In the case that RX_DELV is behind or lower than the reconfigured PDCP state variable value, the UE will set a state variable indicating a count value of a first PDCP SDU not delivered to upper layers but still waited for, e.g., RX_DELV to the reconfigured PDCP state variable value. Correspondingly, the UE may adjust other PDCP state variables, e.g., setting RX_NEXT to zero. If a timer for detecting PDCP data lost, e.g., t-Reordering is running, the UE will stop and reset the timer. The UE will deliver all stored PDCP SDUs to the upper layers, e.g., RRC layer etc. upper than the PDCP layer in an ascending order of associated count values, e.g., after performing header decompression. In the case that the exiting value of a state variable indicating a count value of a first PDCP SDU not delivered to upper layers, e.g., RX_DELV is ahead or larger than the reconfigured PDCP state variable value, the UE will maintain (keep, or not change) the existing values of PDCP variables for the multicast MRB, e.g., maintaining the current RX_NEXT, RX_DELV. RX_REORD and t-Reordering etc.

FIG. 3 illustrates another exemplary procedure of a method of supporting MBS according to some other embodiments of the present application, wherein cell reselection occurs and the second MRB configuration information is transmitted to the UE side via MCCH. Although the method is illustrated in a system level among a UE, a last serving RAN node of the UE, e.g., gNB 1 (also referred to as: a last serving gNB, anchor gNB, old serving gNB, old gNB, last serving RAN side, last serving gNB side or last serving NG-RAN or the like) and a receiving RAN node of the UE, e.g., gNB 2 (also referred to as: a receiving gNB, new serving gNB, new gNB, receiving RAN side, new serving gNB side or new NG-RAN or the like); persons skilled in the art should understand that the method implemented in the UE, last serving RAN node and receiving RAN node can be separately implemented and/or incorporated by other apparatus with the like functions.

Referring to FIG. 3, for a UE in a RRC connected state, e.g., in a first cell belonging to gNB1, the network side, e.g., gNB1 may transmit first MRB configuration information to the UE in step 301 via a RRC dedicated signaling, e.g., RRCReconfiguration message, so that the UE can receive multicast MRB. gNB1 will provide a PDCP related initial value to the UE for the multicast reception of the MRB. e.g., by including the multicastHFN-AndRefSN IE as specified in TS 38.331 in the first MRB configuration information.

Consistently, the UE will receive the multicast MRB according to the first MRB configuration information. Wherein, the UE will use the indicated PDCP related initial value to set the initial values of PDCP state variables, e.g. setting RX_DELIV to the PDCP related initial value, e.g., multicastHFN-AndRefSN indicated in multicastHFN-AndRefSN IE. Then, the UE will determine the count value of the received PDCP data PDU, e.g., RCVD_COUNT as specified in TS 38. 323.

In some scenarios, the UE will be released (or sent) to a RRC non-connected state, e.g., a RRC inactive state, and gNB1 may configure the UE to continue the multicast reception in the RRC inactive state. Then, before sending the UE to the RRC inactive state, gNB1 may decide a list of cells where the UE may receive the multicast MRB in the RRC non-connected state. The cells on the list may belong to gNB1 and/or neighbor RAN node(s) including gNB2. In step 303, gNB1 may transmit a request, e.g., by Xn-AP signaling to each neighbor RAN node where one or more cells in the list of cells belong. Each request to a corresponding neighbor RAN node will request an associated MRB ID of the multicast MRB in each cell belonging to the corresponding neighbor RAN node. In response to the request, the corresponding neighbor RAN node, e.g., gNB2 will transmit the associated MRB ID in each corresponding cell (partial or all of the one or more cells) to gNB1 in step 305, e.g., by Xn-AP signaling. The associated MRB IDs in different cells may be the same or different. Accordingly, gNB1 will receive at least one MRB ID in a set of cells from the neighbor RAN nodes including gNB2.

Different from embodiments illustrated in FIG. 2, in step 307, gNB1 will transmit the associated MRB IDs of the set of cells to the UE with (e.g., included in) the second configuration information via MCCH.

The UE will monitor the MCCH to obtain the second MRB configuration information with the associated MRB IDs, so that the UE will receive the multicast MRB in the RRC inactive state based on the received second MRB configuration information. The UE will inherit the PDCP state variable values of the received PDCP data PDU counted in the RRC connected state for continuing reception of the multicast MRB in the RRC inactive state. For example, the UE will continue using the latest PDCP variables of multicast reception in the RRC connected state for multicast reception in the RRC inactive state.

In the case that the UE moves into the coverage of another RAN node, e.g., gNB2 and reselects a second cell (reselected cell) belonging to gNB2, the UE will monitor the MCCH in the second cell to obtain MRB configuration information for multicast reception in RRC inactive state in the second cell (the third MRB configuration information). The UE will apply the corresponding third MRB configuration information of the reselected cell for multicast reception. The UE will identify the MRB with the associated MRB ID in the reselected cell which is provided in the second MRB configuration information and associate the MRB with the PDCP entity. The UE will inherit the PDCP state variable values of the received PDCP data PDU in the source cell before the cell reselection (e.g., the first cell) for continuing reception of the multicast MRB in the reselected cell (e.g., the second cell).

In some scenarios, the UE may enter the RRC connected state from the RRC inactive state in the second cell by performing a RRC state transition. In step 309. the UE will transmit HFN ambiguity indication information to gNB2, e.g. via a RRC message, e.g., RRCSetupComplete message or MBSInterestIndication message or other RRC message, or via a PDCP control PDU. The HFN ambiguity indication information indicates that there is ambiguity in HFN of the received PDCP data PDU associated with the multicast MRB, e.g., RCVD_HFN in the UE (or HFN of the received PDCP data PDU associated with the multicast MRB may be wrong in the UE). As stated above, the HFN ambiguity indication information can be indicated in various manners and will not be repeated.

After receiving the HFN ambiguity indication information, gNB2 may decide to reconfigure PDCP state variables for the multicast MRB, e.g., based on the implementation of gNB2. In step 311, gNB2 will transmit information indicating a reconfigured PDCP state variable value for the multicast MRB to the UE according to the HFN ambiguity indication information. An exemplary reconfigured PDCP state variable value may be multicastHFN-AndRefSN in multicastHFN-AndRefSN IE included in a RRC message. In some embodiments of the present application, gNB2 may also transmit additional indication information indicating that a PDCP state variable for the multicast MRB is reconfigured to the UE, which can also be included in the multicastHFN-AndRefSN IE, e.g., by adding new indication information compared with legacy multicastHFN-AndRefSN IE.

In the case of receiving the information indicating a reconfigured PDCP state variable value for the multicast MRB, the UE will perform a reconfiguration procedure of PDCP state variable of the multicast MRB in step 313, which is identical to that illustrated in step 213 and thus will not be repeated.

In some other scenarios, e.g., a handover in RRC connected state, the UE may also perform a reconfiguration procedure of PDCP state variable of the multicast MRB according to a reconfigured PDCP state variable value provided by the target RAN node.

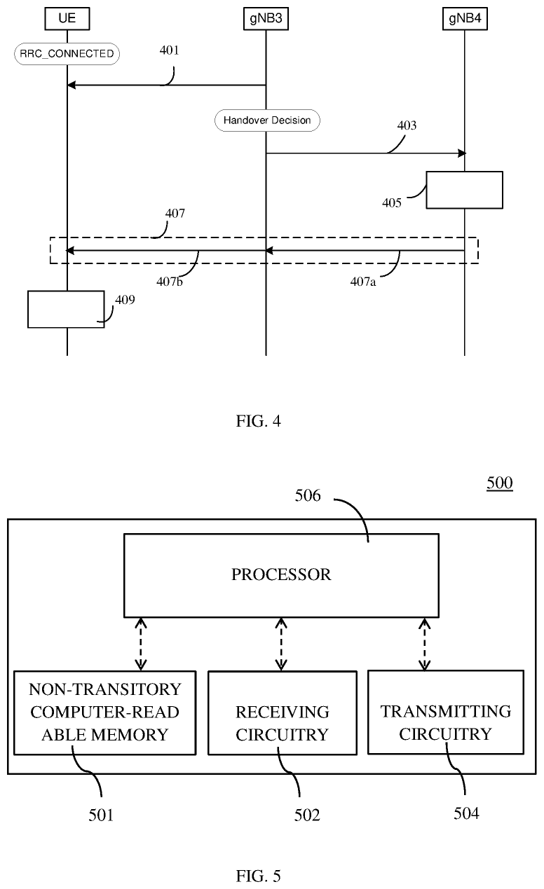

FIG. 4 illustrates an exemplary procedure of a method of supporting MBS according to some yet other embodiments of the present application, wherein a handover of UE in the RRC connected state occurs. Although the method is illustrated in a system level among a UE, a source RAN node of the UE, e.g., gNB 3 and a target RAN node of the UE, e.g., gNB 4; persons skilled in the art should understand that the method implemented in the UE, source RAN node and target RAN node can be separately implemented and/or incorporated by other apparatus with the like functions.

Referring to FIG. 4, for a UE in the RRC connected state, the network side, e.g., gNB3 may transmit first MRB configuration information to the UE in step 401 via a RRC dedicated signaling, e.g., RRCReconfiguration message, so that the UE can perform multicast reception of MRB. gNB3 will provide a PDCP related initial value to the UE for the multicast reception of the MRB, e.g., by including the multicastHFN-AndRefSN IE as specified in TS 38.331 in the first MRB configuration information.

Consequently, the UE will receive the multicast MRB according to the first MRB configuration information. Wherein, the UE will use the indicated PDCP related initial value to set the initial values of PDCP state variables, e.g. setting RX_DELIV to the PDCP related initial value indicated in multicastHFN-AndRefSN IE. Then, the UE will determine the count value of the received PDCP data PDU, e.g., RCVD_COUNT as specified in TS 38. 323.

In some scenarios, gNB3 may decide to handover the UE to a target RAN node, e.g., gNB4. gNB3 will transmit information related to a latest count value of transmitted PDCP data PDU of the multicast MRB (hereafter, latest count value information) to gNB3 in step 403. For example, gNB3 will include the latest count value information in a handover related signaling, e.g. Handover Request message. The latest count value information can be expressed in various manners. For example, the latest count value information may indicate the highest PDCP count value of PDCP PDU of the multicast MRB transmitted to the UE in the source RAN node, e.g., gNB3 (regardless of whether being successfully transmitted), or the highest HFN value of PDCP PDU of the multicast MRB transmitted to the UE in gNB3 (regardless of whether being successfully transmitted). In some embodiments of the present application, the highest PDCP count value of PDCP PDU of the multicast MRB transmitted to the UE in gNB3 may be the highest PDCP count value of PDCP PDU of the multicast MRB transmitted to UE successfully in order in gNB3. Similarly, the highest HFN value of PDCP PDU of the multicast MRB transmitted to the UE in gNB3 may refer to the highest HFN value of PDCP PDU transmitted to UE successfully in order in gNB3.

In step 405, gNB4 will determine whether to reconfigure PDCP state variables for the multicast MRB based on the latest count value information and transmission status of the multicast MRB in gNB4.

For example, the latest count value information indicates the highest PDCP count value of PDCP PDU of the multicast MRB transmitted to the UE in gNB3, and the target gNB, e.g., gNB4 may decide to reconfigure the PDCP state variables in the case that the highest PDCP count value of PDCP PDU of the multicast MRB to be transmitted to the UE in gNB4 is larger than the indicated highest PDCP count value of the multicast MRB transmitted to the UE in gNB3. In another example, the latest count value information indicates the highest HFN value of PDCP PDU of the multicast MRB transmitted to the UE in gNB3, and gNB4 may decide to reconfigure the PDCP state variables in the case that the highest HFN value of PDCP PDU of the multicast MRB to be transmitted to the UE in gNB4 is larger than the indicated highest HFN value of PDCP PDU of the multicast MRB transmitted to the UE in gNB3. It is similar to other cases that the latest count value information indicates the highest PDCP count value of PDCP PDU of the multicast MRB transmitted to UE successfully in order in gNB3, or the highest HFN value of PDCP PDU transmitted to UE successfully in order in gNB.

Some embodiments of the present application also provide another solution of deciding whether to reconfigure the PDCP state variables. For example, gNB4 may decide to maintain the PDCP state variables in the case that the difference between the highest PDCP count value (or HFN value) of PDCP PDU of the multicast MRB to be transmitted to the UE in gNB4 and the highest PDCP count value (or HFN value) indicated in the latest count value information is smaller than a threshold, that is, no PDCP state variable will be reconfigured. Similarly, gNB4 may decide to maintain the PDCP state variables in the case that the difference between the highest PDCP count value (or HFN value) of PDCP PDU of the multicast MRB to be transmitted to the UE successfully in order in gNB4 and the indicated highest PDCP count value (or HFN value) successfully in order is smaller than a threshold. The threshold can be based on the target implementation in some scenarios.

In the case that gNB4 decides to reconfigure PDCP state variables, gNB4 will transmit information indicating a reconfigured PDCP state variable value in step 407, e.g., with the first MRB configuration information configured by gNB4 for the UE. Similarly, an exemplary reconfigured PDCP state variable value includes a reconfigured HFN and reference SN of the multicast MRB, which is similar to the PDCP related initial value as illustrated above. For example, the reconfigured PDCP state variable value may be multicastHFN-AndRefSN in multicastHFN-AndRefSN IE included in a RRC message. For example, gNB4 may transmit the multicastHFN-AndRefSN IE in the RRC container in a Handover Request Acknowledge message to gNB3 with the first MRB configuration information configured by gNB4 in step 407a. After receiving the first MRB configuration information configured by gNB4 with the reconfigured PDCP state variable value, e.g., multicastHFN-AndRefSN, gNB3 will transfer to the UE via a handover command in step 407b.

In some other embodiments of the present application, gNB4 may also transmit additional indication information indicating that a PDCP state variable for the multicast MRB is reconfigured to the UE. Similarly, the indication information can also be included in the multicastHFN-AndRefSN IE, e.g., by adding new indication information compared with legacy multicastHFN-AndRefSN IE.

In the case of receiving the information indicating a reconfigured PDCP state variable value for the multicast MRB, the UE will perform a reconfiguration procedure of PDCP state variable of the multicast MRB in step 409, which is identical to that illustrated in step 213 and will not be repeated.

Besides cell reselection and handover, the UE may also perform a similar reconfiguration procedure of PDCP state variable of multicast MRB in other some scenarios, e.g., scenarios of RRC based MRB type change. In scenarios of RRC based MRB type change, the UE may perform a similar reconfiguration procedure of PDCP state variable of multicast MRB with the reconfigured PDCP state variable value provided by the serving RAN node, which can be provided by the serving RAN node based on implementation.

Considering that existing PDCP state variables will be changed according to a reconfigured PDCP state variable value, embodiments of the present application also provide a solution of setting PDCP status report in response to receiving a reconfigured PDCP state variable value. For example, the UE will set the PDCP status report for the multicast MRB based on the PDCP state variable values before performing the reconfiguration procedure of PDCP state variables (in any scenario as illustrated above or the like). For example, if the multicastHFN-AndRefSN is reconfigured, the UE shall, store the RX_DELV and bitmaps for PDCP status reporting according to the latest receiving status before setting PDCP state variable values to the initial value, and then set RX_NEXT and RX_DELV to the initial value (i.e. RX_NEXT=0, RX_DELV=multicastHFN-AndRefSN).

An exemplary solution of setting the PDCP status report may include storing a state variable indicating a count value of a first PDCP SDU not delivered to upper layers but still waited for, e.g., RX_DELV and bitmaps for the PDCP status report according to the latest receiving status of the multicast MRB before setting the state variables with the reconfigured PDCP state variable value. Whether to generate the PDCP status report is event triggered as the legacy. Different from that, according to another exemplary solution of setting the PDCP status report, the UE will generate the PDCP status report according to the latest receiving status of the multicast MRB before setting the state variables with the reconfigured PDCP state variable value.

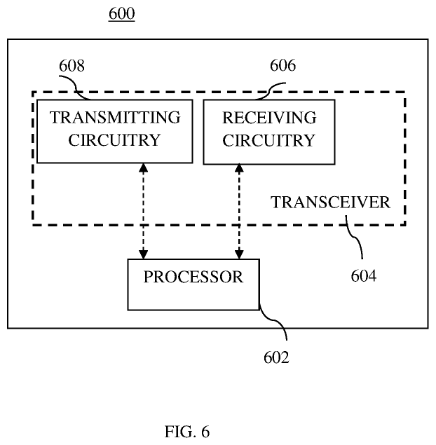

Besides methods, embodiments of the present application also propose an apparatus of supporting MBS. For example, FIG. 5 illustrates a block diagram of an apparatus 500 of supporting MBS according to some embodiments of the present application.

As shown in FIG. 5, the apparatus 500 may include at least one non-transitory computer-readable medium 501, at least one receiving circuitry 502, at least one transmitting circuitry 504, and at least one processor 506 coupled to the non-transitory computer-readable medium 501, the receiving circuitry 502 and the transmitting circuitry 504. The at least one processor 506 may be a CPU, a DSP, a microprocessor etc. The apparatus 500 may be a UE, or a RAN node (e.g., a serving RAN node, a last serving RAN node, a target RAN node or a receiving RAN node) configured to perform a method illustrated in the above or the like.

Although in this figure, elements such as the at least one processor 506, transmitting circuitry 504, and receiving circuitry 502 are described in the singular, the plural is contemplated unless a limitation to the singular is explicitly stated. In some embodiments of the present application, the receiving circuitry 502 and the transmitting circuitry 504 can be combined into a single device, such as a transceiver. In certain embodiments of the present application, the apparatus 500 may further include an input device, a memory, and/or other components.

In some embodiments of the present application, the non-transitory computer-readable medium 501 may have stored thereon computer-executable instructions to cause a processor to implement the method with respect to a remote apparatus, e.g., a UE as described above. For example, the computer-executable instructions, when executed, cause the processor 506 to interact with receiving circuitry 502 and transmitting circuitry 504, so as to perform the steps with respect to a remote apparatus as depicted above, e.g., shown in FIG. 2, FIG. 3 or FIG. 4.

In some embodiments of the present application, the non-transitory computer-readable medium 501 may have stored thereon computer-executable instructions to cause a processor to implement the method with respect to a RAN node, e.g., a serving RAN node, a last serving RAN node, a target RAN node, or a receiving RAN node as described above. For example, the computer-executable instructions, when executed, cause the processor 506 interacting with receiving circuitry 502 and transmitting circuitry 504, so as to perform the steps with respect to a last serving RAN node or a receiving RAN node as depicted above, e.g., shown in FIG. 2 or FIG. 3. In another example, the computer-executable instructions, when executed, cause the processor 506 to interact with receiving circuitry 502 and transmitting circuitry 504, so as to perform the steps with respect to a source RAN node or a target RAN node as depicted above, e.g., shown in FIG. 4.

FIG. 6 is a block diagram of an apparatus of supporting MBS 600 according to some other embodiments of the present application.

Referring to FIG. 6, the apparatus 600, for example a UE or a RAN node may include at least one processor 602 and at least one transceiver 604 coupled to the at least one processor 602. The transceiver 604 may include at least one separate receiving circuitry 606 and transmitting circuitry 608, or at least one integrated receiving circuitry 606 and transmitting circuitry 608. The at least one processor 602 may be a CPU, a DSP, a microprocessor etc.

According to some embodiments of the present application, the apparatus 600 is a remote apparatus, e.g., a UE. The UE may include: a transceiver; and a processor coupled to the transceiver, wherein the processor is configured to: transmit, via the transceiver, HFN ambiguity indication information to a RAN node, indicating that there is ambiguity in HFN of received PDCP data PDU associated with a multicast MRB in the UE; and perform a reconfiguration procedure of PDCP state variable of the multicast MRB in response to receiving information indicating a reconfigured PDCP state variable value for the multicast MRB.

According to some other embodiments of the present application, the apparatus 600 is a RAN node, e.g., a receiving RAN node. The receiving gNB may include: a transceiver; and a processor coupled to the transceiver, wherein the processor is configured to: receive, via the transceiver, HFN ambiguity indication information from a UE, indicating that there is ambiguity in HFN of received PDCP data PDU of a multicast MRB in the UE; and transmit, via the transceiver, information indicating a reconfigured PDCP state variable value for the multicast MRB according to the HFN ambiguity indication information.

According to some yet other embodiments of the present application, the apparatus 600 is a RAN node, e.g., a last serving gNB, which includes: a transceiver; and a processor coupled to the transceiver, wherein the processor is configured to: transmit, via the transceiver, configuration information for reception of a multicast MRB to a UE in a RRC connected state; and transmit, via the transceiver, information indicating at least one associated MRB ID of the multicast MRB to the UE in response to that the UE transits to a RRC inactive state from the RRC connected state, wherein each associated MRB ID of the multicast MRB is associated a neighbor cell of the first cell.

According to some yet other embodiments of the present application, the apparatus 600 is a RAN node, e.g., a last serving gNB, which includes: a transceiver; and a processor coupled to the transceiver, wherein the processor is configured to: decide to handover a UE during reception of a multicast MRB to a target RAN node; and transmit, via the transceiver, information related to a latest count value of transmitted PDCP data PDU of the multicast MRB to the target RAN node.

According to some yet other embodiments of the present application, the apparatus 600 is a RAN node, e.g., a target gNB, which includes: a transceiver; and a processor coupled to the transceiver, wherein the processor is configured to: receive, via the transceiver, from a source RAN node of a UE, information related to a latest count value of transmitted PDCP data PDU of a multicast MRB; determine whether to reconfigure PDCP state variables for the multicast MRB based on the information related to a latest count value of transmitted PDCP data PDU and transmission status of the multicast MRB in the RAN node; and transmit, via the transceiver, to the UE, information indicating a reconfigured PDCP state variable value in response to determining to reconfigure the PDCP state variables.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE), comprising:
at least one memory; and
at least one processor coupled with the at least one memory and configured to cause the UE to:
transmit hyper frame number (HFN) ambiguity indication information to a radio access network (RAN) node indicating that there is ambiguity in HFN of received packet data convergence protocol (PDCP) data protocol data unit (PDU) associated with a multicast multicast/broadcast services (MBS) radio bearer (MRB) in the UE; and
perform a reconfiguration procedure of PDCP state variable of the multicast MRB in response to receiving information indicating a reconfigured PDCP state variable value for the multicast MRB.

2. The UE of claim 1, wherein the RAN node is a receiving RAN node in response to occurrence of a cell reselection due to mobility of the UE in a radio resource control (RRC) inactive state.

3. The UE of claim 2, wherein the at least one processor is configured to cause the UE to:
inherit PDCP state variable values of the received PDCP data PDU counted in a source cell before the cell reselection for continuing reception of the multicast MRB in a selected cell after the cell reselection in response to the cell reselection.

4. The UE of claim 2, wherein the at least one processor is configured to cause the UE to:
identify the multicast MRB with an associated MRB identity in a selected cell; and
associate the multicast MRB with a PDCP entity for the multicast MRB in response to the cell reselection to inherit PDCP state variable values of the received PDCP data PDU counted in a source cell before the cell reselection.

5. The UE of claim 1, wherein performing the reconfiguration procedure of PDCP state variable of the multicast MRB comprises the following:
setting a state variable indicating a count value of a first PDCP service data unit (SDU) not delivered to upper layers but still waited for to the reconfigured PDCP state variable value; and
delivering all stored PDCP SDUs to the upper layers in an ascending order of associated count values.

6. The UE of claim 1, wherein performing the reconfiguration procedure of PDCP state variable of the multicast MRB comprises the following:
if an existing value of a state variable indicating a count value of a first PDCP service data unit (SDU) not delivered to upper layers is behind or lower than the reconfigured PDCP state variable value,
setting a state variable indicating a count value of a first PDCP service data unit (SDU) not delivered to upper layers but still waited for to the reconfigured PDCP state variable value; and
delivering all stored PDCP SDUs to the upper layers in an ascending order of associated count values; and
if an exiting value of a state variable indicating a count value of a first PDCP SDU not delivered to upper layers is ahead or larger than the reconfigured PDCP state variable value, maintaining existing values of PDCP variables for the multicast MRB.

7. The UE of claim 1, wherein the at least one processor is configured to cause the UE to:
set a PDCP status report for the multicast MRB based on PDCP state variable values before performing the reconfiguration procedure.

8. The UE of claim 7, wherein setting the PDCP status report for the multicast MRB based on the PDCP state variable values before performing the reconfiguration procedure comprises:
storing a state variable indicating a count value of a first PDCP service data unit (SDU) not delivered to upper layers but still waited for and bitmaps for the PDCP status report according to latest receiving status of the multicast MRB before setting the state variable with the reconfigured PDCP state variable value; or
generating the PDCP status report before setting the state variable with the reconfigured PDCP state variable value.

9. The UE of claim 1, wherein the HFN ambiguity indication information indicates that cell reselection occurred during reception of the multicast MRB to implicitly indicate that there is ambiguity in the HFN of received PDCP data PDU in the UE.

10. A radio access network (RAN) node, comprising:
at least one memory; and
at least one processor coupled with the at least one memory and configured to cause the RAN node to:
receive hyper frame number (HFN) ambiguity indication information from a user equipment (UE), indicating that there is ambiguity in HFN of received packet data convergence protocol (PDCP) data protocol data unit (PDU) of a multicast multicast/broadcast services (MBS) radio bearer (MRB) in the UE; and
transmit information indicating a reconfigured PDCP state variable value for the multicast MRB according to the HFN ambiguity indication information.

11. A radio access network (RAN node), comprising:
at least one memory; and
at least one processor coupled with the at least one memory and configured to cause the RAN node to:
transmit configuration information for reception of a multicast multicast/broadcast services (MBS) radio bearer (MRB) to a user equipment (UE) in a radio resource control (RRC) connected state; and
transmit information indicating at least one associated MRB identity (ID) of the multicast MRB to the UE in response to that the UE transits to a RRC inactive state from the RRC connected state, wherein each associated MRB ID of the multicast MRB is associated with a corresponding neighbor cell belonging to an associated one of at least one neighbor RAN node of the RAN node.

12. The RAN node of claim 11, wherein, before releasing the UE to the RRC inactive state, the at least one processor is configured to cause the RAN node to:
transmit at least one request to the at least one neighbor RAN node of the RAN node, each request to a corresponding neighbor RAN node requesting an associated MRB ID of the multicast MRB in each of one or more cells belonging to the corresponding neighbor RAN node; and
receive the at least one associated MRB ID from the at least one neighbor RAN node.

13. (canceled)

14. (canceled)

15. (canceled)

16. A processor for wireless communication, comprising:
at least one controller coupled with at least one memory and configured to cause the processor to:
transmit hyper frame number (HFN) ambiguity indication information to a radio access network (RAN) node indicating that there is ambiguity in HFN of received packet data convergence protocol (PDCP) data protocol data unit (PDU) associated with a multicast multicast/broadcast services (MBS) radio bearer (MRB) in the processor; and
perform a reconfiguration procedure of PDCP state variable of the multicast MRB in response to receiving information indicating a reconfigured PDCP state variable value for the multicast MRB.

17. The processor of claim 16, wherein the RAN node is a receiving RAN node in response to occurrence of a cell reselection due to mobility of the processor in a radio resource control (RRC) inactive state.

18. The processor of claim 17, wherein the at least one controller is configured to cause the processor to:
inherit PDCP state variable values of the received PDCP data PDU counted in a source cell before the cell reselection for continuing reception of the multicast MRB in a selected cell after the cell reselection in response to the cell reselection.

19. The processor of claim 17, wherein the at least one controller is configured to cause the processor to:
identify the multicast MRB with an associated MRB identity in a selected cell; and
associate the multicast MRB with a PDCP entity for the multicast MRB in response to the cell reselection to inherit PDCP state variable values of the received PDCP data PDU counted in a source cell before the cell reselection.

20. The processor of claim 16, wherein performing the reconfiguration procedure of PDCP state variable of the multicast MRB comprises the following:
setting a state variable indicating a count value of a first PDCP service data unit (SDU) not delivered to upper layers but still waited for to the reconfigured PDCP state variable value; and
delivering all stored PDCP SDUs to the upper layers in an ascending order of associated count values.

21. The processor of claim 16, wherein performing the reconfiguration procedure of PDCP state variable of the multicast MRB comprises the following:
if an existing value of a state variable indicating a count value of a first PDCP service data unit (SDU) not delivered to upper layers is behind or lower than the reconfigured PDCP state variable value,
setting a state variable indicating a count value of a first PDCP service data unit (SDU) not delivered to upper layers but still waited for to the reconfigured PDCP state variable value; and
delivering all stored PDCP SDUs to the upper layers in an ascending order of associated count values; and
if an exiting value of a state variable indicating a count value of a first PDCP SDU not delivered to upper layers is ahead or larger than the reconfigured PDCP state variable value, maintaining existing values of PDCP variables for the multicast MRB.

22. The processor of claim 16, wherein the at least one controller is configured to cause the processor to:
set a PDCP status report for the multicast MRB based on PDCP state variable values before performing the reconfiguration procedure.

23. The processor of claim 22, wherein setting the PDCP status report for the multicast MRB based on the PDCP state variable values before performing the reconfiguration procedure comprises:
storing a state variable indicating a count value of a first PDCP service data unit (SDU) not delivered to upper layers but still waited for and bitmaps for the PDCP status report according to latest receiving status of the multicast MRB before setting the state variable with the reconfigured PDCP state variable value; or
generating the PDCP status report before setting the state variable with the reconfigured PDCP state variable value.
